(19) United States
(12) Patent Application Publication
(10) Pub. No.: US 2026/0269208 A1
(43) Pub. Date: Sep. 10, 2026

(54) CUTTING METHOD AND CUTTING DEVICE FOR SINGULATING ELECTRODE PIECES FROM A WEB-SHAPED ELECTRODE SUBSTRATE

(71) Applicant: GROB-WERKE GmbH & Co. KG, MINDELHEIM (DE)

(72) Inventors: Moritz GLÜCK, POLLING (DE); Markus SCHUSTER, PFAFFENHAUSEN (DE)

(21) Appl. No.: 18/876,297

(22) PCT Filed: Jun. 12, 2023
(86) PCT No.: PCT/EP2023/065641

§ 371 Date: Dec. 18, 2024

(30) Foreign Application Priority Data
Jun. 20, 2022 (DE) 102022002218.4
Dec. 5, 2022 (EP) 22211499.3

(51) Int. Cl. H01M 4/04; B23K 26/08; B23K 26/38; B23K 101/36

(52) U.S. Cl. CPC H01M 4/04; B23K 26/08; B23K 26/38; B23K 2101/36

(57) ABSTRACT

A method and device for separation of electrode pieces for large-scale production of battery cells for electric vehicles or the like, in which, while an electrode substrate is being conveyed, at least one arrester lug is cut free from an arrester strip of an electrode substrate by a cutting apparatus, wherein, when viewed in a conveying direction, after the arrester lug, a portion of unneeded material of the arrester strip is created, and then the electrode pieces provided with the cut-free arrester lug are separated by cutting through the electrode substrate, including active material and also the portion cut out.

This application is a national phase of International Patent Application No. PCT/EP2023/065641, filed on Jun. 12, 2023, which claims the benefit of German Patent Application No. 10 2022 002 218.4, filed on Jun. 20, 2022, and the benefit of European Patent Application No. 22 211499.3, filed on Dec. 5, 2022, the entire disclosures of which are incorporated herein by way of reference.

### FIELD OF THE INVENTION

The invention relates to a cutting method to be carried out in the course of series production of cell composites of batteries for singulating electrode pieces from a web-shaped electrode substrate by means of a cutting device in order to obtain electrode pieces with a flat active material and a lateral arrester tab. The invention also relates to a cutting device for cutting out and cutting off electrode pieces from a web-shaped electrode substrate in order to obtain electrode pieces with a flat active material and a lateral arrester tab for the series production of cell composites for batteries. Furthermore, the invention relates to a computer program with control instructions for carrying out the cutting method, and to a use of the cutting method or the cutting device or the computer program in a series production of cell composites for batteries, in particular for electric vehicles.

### BACKGROUND OF THE INVENTION

For the technological background, reference is made to the following literature describing such cutting methods and cutting devices:
[1] WO 2020/192845 A1
[2] EP 3 415 265 A1
[3] https://www.youtube.com/watch?v=XStpCqpgZOg
[4] https://www.youtube.com/watch?v=vXfJeHxbQKA

In battery cell production, the separation of electrodes on an industrial scale is carried out by a mechanical separation cut or laser cut.

Two cutting processes are usually provided in the production:
1. cutting out the arrester contour (“notching”)
2. separation cut of the electrodes for singulating

As can be seen from [3] and [4], the two processes are normally carried out in separate systems, i.e. the electrode material is unwound, notched and rewound in the first system. The coil is then fed to a second system where stacking takes place. There, the notched webs are then cut by laser or mechanically to produce the individual electrodes. In [3] and [4], the processing in two separate steps can be seen. There are separate systems for notching (see [3]) as well as combined processes (see [4]). However, it can be seen that several units for web guiding and positioning are necessary between notching and cutting (deflection rollers, rotating frames, etc.). One disadvantage of these methods is on the one hand that many handling steps are necessary (separate systems, direction change between the processes in a system). These have a negative influence on the material and the risk of damage is very high. On the other hand, the inaccuracy of the geometry also increases as a result of linking several independent process steps, which means that the manufacturing tolerances must be set larger.

In some cases, both processes are combined in a single system, with the web being guided between the two processes by means of web guide systems (rollers, web tension measuring rollers and rotating frames).

The reason for this is that the web must be precisely positioned (lateral orientation) before cutting so that the geometry of the electrodes is achieved after separation.

A cutting device and a cutting method for singulating the electrodes are known from [2]. Only one separation cut is carried out on a roller. The additional cut intended to create an arrester contour is carried out in an upstream process.

A combined cutting and fixing device for producing cell composites is known from [1], in which many of the above-mentioned disadvantages are already avoided.

### SUMMARY OF THE INVENTION

Based on [1], an object of the present invention is to further improve the cutting of electrode pieces.

To achieve this object, the invention provides a cutting method and a cutting device according to one or more embodiments is described herein.

Advantageous embodiments are also described herein. A computer program with control instructions for automatically executing the cutting process as well as advantageous uses are also disclosed herein.

According to one aspect, the invention provides a cutting method to be carried out in the course of series production of cell composites of batteries for singulating electrode pieces from a web-shaped electrode substrate by means of a cutting device in order to obtain electrode pieces with a flat active material and a lateral arrester tab, the method comprising the steps of:
a) providing the web-shaped electrode substrate, which has an active material region and an arrester tab on at least one side of the active material region, by conveying the web-shaped electrode substrate to the cutting means;
b) cutting free at least one arrester tab from the arrester strip, in which process a portion of unneeded material of the arrester strip is produced before and/or after the arrester tab in the conveying direction,
c) singulating the electrode piece provided with the arrester tab that has been cut free by cutting through the electrode substrate inclusive of the active material and also the portion cut out in step b), and
d) removal of the cut-out portion parts from the cutting device.

Preferably, the active material is a flat active material coated on one or both sides.

Preferably, an electrode substrate is provided which has an active material region coated on one or both sides and which has the arrester strip on at least one coating edge of the active material region.

The arrester strip is preferably an uncoated arrester strip or edge strip.

In particular, the web-shaped electrode substrate has an electrically conductive base layer which is coated on one or both sides with active material in the active material region to form the respective battery electrode and is uncoated on at least one edge strip and thus forms the arrester strip. In principle, such an electrode substrate is well known and available on the market.

Preferably, the web-shaped electrode substrate is conveyed to the processing field of cutting units of the cutting device.

Preferably, the cutting operation for singulating and/or for cutting through the electrode piece and/or the portion is carried out at least partially transversely to the running direction of the web of the electrode substrate (conveying direction). In some embodiments, it is provided that when the cutting operation is carried out for singulation, cutting also takes place in or against the running direction of the web. For example, the portion is cut out by a longitudinal cut.

In step d), safe and complete removal of all portion parts from the cutting device can be achieved, so that interference of the cutting process for subsequent electrode pieces by remaining portion parts is avoided.

Preferably, removal takes place using of a suction means which, even more preferably, permanently extracts air or other ambient medium at the processing region of the cutting units in order to avoid interference of the cutting beams by particles produced during cutting.

In some embodiments, additional blowing units are provided to generate a directed air stream in conjunction with the suction and to additionally protect the beam exit regions on the optics from contamination.

Cutting through the portion reduces its size and breaks it down into several portion parts, so that it can be removed more easily and the cutting process is not disturbed by larger defective remaining portions. This is generally possible with different cutting strategies, e.g. also when cutting units operate sequentially or, for example, when one cutting unit of the cutting means is only used to cut the arrester tab free and the other cutting unit of the cutting means is used to cut through the electrode pieces and the portion. Preferably, several cutting units of the cutting device operate synchronously, which results in a shorter cycle time.

It is preferred that step a) comprises:
a1) conveying the electrode substrate through two working regions of a first cutting unit and a second cutting unit of the cutting means, which working regions are arranged one behind the other and/or in an overlapped configuration.

Preferably step b) comprises: cutting at least one arrester tab free from the arrester strip, wherein a first portion of unneeded material is produced at least after the arrester tab in the conveying direction. The free-cutting operation can also be carried out in such a way that a portion of unneeded material of the arrester strip is additionally produced before the arrester tab in the conveying direction. The method used to cut the arrester tab free depends on the format of the electrode. If, for example, an electrode format is to be produced in which the rear edge of the arrester corresponds to an edge of the active material (i.e. the arrester tab is located at the very rear of the electrode with respect to the conveying direction), the portion is produced (only) in front (in the running direction of the web).

It is preferred that in step b) a portion before the arrester tab in the conveying direction is cut out by means of the first cutting unit and, simultaneously, synchronously or with a time overlap, a second portion after that arrester tab in the conveying direction is cut out by means of the second cutting unit.

It is preferred that in step c) a front transection in the conveying direction is carried out by means of the first cutting unit and, simultaneously, synchronously or with a time overlap, a rear transection in the conveying direction is carried out by means of the second cutting unit.

To perform the front or rear transection, a separation cut, in particular a transverse cut, is preferably performed.

Accordingly, it is preferred that several cutting units of the cutting means operate simultaneously or at least with a time overlap. In the case of a time overlap, one cutting unit operates with a delay in relation to the other cutting unit. In the case of a delayed operation, for example, the first cut (arrester contour+separation cut) is made by a first scanner (example for first cutting unit) and, with a time offset from this, the second separating cut is made by a second scanner (example for second cutting unit).

The processing areas or working regions of the first and second cutting units can be arranged entirely one after the other, as seen in the conveying direction (so that there is no overlap region). Preferably, the processing areas or working regions are offset from one another in the conveying direction, but overlap. This has advantages in keeping the space required for the cutting device as small as possible.

The cutting method preferably comprises the steps of:
generating at least one cutting beam, in particular a laser beam, and
directing the at least one cutting beam along cutting curves in order to carry out steps b) and c).

Directing the at least one cutting beam preferably takes place by deflecting the at least one cutting beam. The directing or deflecting operation is preferably carried out to singulate an electrode and/or to cut the arrester tab free during the conveying process. Preferably, automatically calculated-in particular three-dimensional-cutting paths, in particular laser tracks, are provided as cutting curves, in which the conveying movement and/or the cutting position is taken into account. Preferably, the cutting paths are dependent on the conveying movement and are-preferably automatically-adjusted accordingly when the conveying movement changes.

It is preferred that step b) comprises:
b1) directing the at least one cutting beam along a front cutting curve (in particular cutting path) that extends from a beam entry point in the interior of a region of the arrester strip forming the later unneeded portion of the arrester strip to a front corner region between an arrester tab at the front with respect to the conveying direction and the active material of the electrode piece and then extends outwards from the front corner region in a direction transverse to the conveying direction to separate the front arrester tab from the remaining unneeded portion of the arrester strip.

It is preferred that step b) comprises:
b2) directing the at least one cutting beam along a rear cutting curve that extends from a beam entry point in the interior of the portion of the arrester strip forming the later unneeded portion of the arrester strip to a rear corner region between an arrester tab at the rear with respect to the conveying direction and the active material of the electrode piece and then extends outwards from the rear corner region in a direction transverse to the conveying direction to separate the rear arrester tab from the remaining unneeded portion of the arrester strip.

It is preferred that step b) comprises:
b3) directing the cutting beam along a middle cutting curve that extends from the interior of the portion to a corner region between a first arrester tab and the active material of the electrode piece, then in the conveying direction to produce an end edge of the active material of the electrode piece between the first arrester tab and a second arrester tab adjacent thereto and from that corner region between the second arrester tab and the active material into the interior of the portion and ends there.

It is preferred that step c) comprises:
c1) directing the at least one cutting beam along a singulation cutting curve that extends from outside the arrester strip through the portion across the electrode substrate to separate the electrode piece. Preferably, the cutting curve runs across the electrode substrate in a coordinate system that moves with the electrode substrate; transferred to a fixed coordinate system, the gradient of the cutting curve (e.g. laser beam) is steeper or shallower, depending on the web speed.

It is preferred that the cutting beam traverses the cutting curves one after the other, preferably with deactivation or fading of the cutting beam at the jump from cutting curve to cutting curve. In particular, a laser beam preferably used as a cutting beam is automatically switched on and off by a control system of the beam deflection units and the laser.

It is preferred that the middle curve is traversed after the front and the rear cutting curves.

It is preferred that the steps are carried out in the order of b1), b2), b3) and c1).

It is preferred that d) comprises:
blowing off or sucking off the portion parts.

Removal, in particular by blow off or extraction, preferably occurs locally and temporally directly at the point of origin.

According to a further aspect, the invention provides a cutting device for cutting out and cutting off electrode pieces from a web-shaped electrode substrate in order to obtain electrode pieces with flat active material and a lateral arrester tab for a series production of cell composites of batteries, the cutting device comprising:
cutting means,
conveyor means for moving a web-shaped electrode substrate, which has an active material region and an arrester tab on at least one side of the active material region, through a working region of the cutting means,
cut portion removal means for removing unneeded portions produced during cutting,
and a control system configured to cause the cutting means to
cut at least one arrester tab free from the arrester strip, wherein a portion of unneeded material of the arrester strip is produced after of the arrester tab in the conveying direction, and
making a transection both through the electrode piece provided with the arrester tab cut free and through the portion cut out in step b) in order to singulate the electrode piece and to divide the portion into a plurality of parts parts in order to remove these by cut portion removal means.

The cutting device, and in particular its control system, is preferably configured to carry out the cutting process in accordance with one or more of the advantageous embodiments of the method explained above. The cutting method is preferably carried out with a cutting device according to one of the advantageous embodiments of the device.

It is preferred that the cutting device comprises at least one cutting unit comprising a cutting beam generating means for generating a cutting beam, in particular a laser, and a cutting beam deflection means, wherein the control system is configured to cause the cutting unit to guide the cutting beam along one or more predetermined cutting curves over the electrode substrate moved by means of the conveyor. Preferably, the control system is configured to cause the cutting unit to switch the cutting beam on or off in accordance with the cutting curve. The cutting curves are preferably the cutting paths already mentioned above, automatically calculated in dependence on the conveying movement, in particular laser paths for the corresponding deflection of the laser beam.

It is preferred that the cutting device has a first cutting unit with a first working region and a second cutting unit with a second working region which are arranged one behind the other and/or overlapping in the conveying direction of the conveyor means,
and that the control system, in particular a control unit of the same for controlling beam deflection units, is configured to cause the cutting device
to cut out a first portion located before the arrester tab in the conveying direction by means of the first cutting unit and, simultaneously, synchronously or with a time overlap, to cut out a second portion after of the arrester tab in the conveying direction by means of the second cutting unit and/or
to carry out a front transection viewed in the conveying direction with the first cutting unit and, simultaneously, synchronously or at least with a time overlap, to carry out a rear transection viewed in the conveying direction with the second cutting unit.

It is preferred that the control system is configured to cause the cutting beam deflection means
b1) to traverse a front cutting curve with the cutting beam, preferably at a predefined point in time, which front cutting curve extends from a beam entry point in the interior of a region of the arrester strip forming the later unneeded portion of the arrester strip to a front corner region between an arrester tab at the front with respect to the conveying direction and the active material of the electrode piece and then extends outwards from the front corner region in a direction transverse to the conveying direction in order to separate the front arrester tab from the remaining unneeded portion of the arrester strip.

It is preferred that the control system is configured to cause the cutting beam deflection means
b2) to traverse a rear cutting curve with the cutting beam, which rear cutting curve extends from a beam entry point in the interior of the region of the arrester strip forming the later unneeded portion of the arrester strip to a rear corner region between an arrester tab at the rear with respect to the conveying direction and the active material of the electrode piece and then extends outwards from the rear corner region in a direction transverse to the conveying direction in order to separate the rear arrester tab from the remaining unneeded portion of the arrester strip.

It is preferred that the control system is configured to cause the cutting beam deflection means
b3) to traverse a middle cutting curve with the cutting beam, which middle cutting curve extends from the interior of the portion to a corner region between a first arrester tab and the active material of the electrode piece, then in the conveying direction to produce an end edge of the active material of the electrode piece between the first arrester tab and a second arrester tab adjacent thereto and from the corner region between the second arrester tab and the active material into the interior of the portion and ends there.

The control system is configured in particular to select, calculate and/or set the cutting curves, in particular three-dimensionally, as a function of the web speed and the absolute position of the web, in particular on the conveyor.

It is preferred that the control system is configured to cause the cutting beam deflection means
c1) to traverse a singulation cutting curve with the cutting beam, which singulation cutting curve extends from outside the arrester strip through the portion across the electrode substrate for singulating the electrode piece.

It is preferred that the control system is configured to cause the cutting means and the conveyor means and the cut portion removal means to carry out the cutting method according to one of the above embodiments.

The cut portion removal means preferably comprises a suction means which further preferably operates continuously during the cutting process and thus does not have to be actively controlled separately during the cutting process. In a preferred embodiment, continuous suction is required for the release of the cutting operation, in particular for each laser cut.

In some embodiments, the cutting device has at least one additional blowing unit which, in conjunction with the suction, generates a directed air stream and also protects the beam exit regions on the optics from contamination.

According to a further aspect, the invention provides a computer program containing instructions that cause a cutting device according to one of the above configurations to carry out the cutting method according to one of the above configurations.

According to a further aspect, the invention proposes a use of the cutting method, the cutting device or the computer program according to one of the above-mentioned advantageous embodiments of the invention in a series production of cell composites of batteries, in particular for electric vehicles.

Advantageous embodiments of the invention relate to a laser cutting method for singulating electrodes. Preferably, the method and the device are used in a large-scale production plant for the manufacture of battery cells. The battery cells are intended in particular for use in electric mobility, in particular for at least partially electric or fully electric vehicles, such as in particular passenger cars or trucks.

In preferred embodiments of the invention, it is provided that a laser system comprising a pulsed laser and a 3D scanner with galvanometric axes is constructed to form at least one, several or all of the cutting units of the cutting device.

In preferred embodiments of the invention, it is provided that the arrester cut (free cut) and the separation cut are carried out on a vacuum roller. Thus, the web of the electrode substrate is not guided between the two cuts and the material is permanently fixed (without relative movement) on the vacuum roller, preferably a cassette thereof.

Advantageous embodiments of the invention are based on the manufacturing process “cell composite stacking”, in which the electrodes are usually singulated in several steps (notching & separation cut) in the method described above.

Taking into account the high sensitivity of the electrode coating to mechanical influences, advantageous embodiments provide for a solution in which the electrode can be singulated in a single cut if possible.

In addition, one of the main factors influencing the performance of a battery cell is the positioning accuracy of the individual layers on top of each other. High positioning accuracy and repeatability of the cutting process enable higher energy density in the cell. The reason for this is that the protrusion of the separator as an isolator between the electrodes can be minimized by a higher cutting accuracy. The resulting reduced construction space corresponds to an identical cell with higher energy density.

Particularly preferred embodiments of the invention are based on the drum concept already described and shown in [1]. There, the electrodes are fixed and singulated on individual cassettes by means of a vacuum. In preferred embodiments of the invention, at least two scanners connected in series are provided as cutting units, and improved cutting strategies are provided compared to [1].

In some embodiments, the singulated electrodes are produced in two steps.

In one step, the arrester region, i.e. the regions of the electrode material that is not coated, is cut out.

The contour of the arrester tab can be designed with rounded corners or also with sharp corners.

In a further step, the electrodes are singulated. In this case, the laser beam cuts through the active material. Here, too, rounded corners can be created via the cutting curve if necessary.

The order of the two cuts as well as the direction of the cut can be adjusted as desired due to the symmetrical structure.

Furthermore, it is conceivable that two electrode webs (or one web with two arrester strips which is centrally separated on the upstream side) can also be processed synchronously by adding a third laser or scanner to the arrangement.

Preferred embodiments have at least one, several or all of the following advantages:
The contour of the electrode can be produced with very small tolerances, since the electrodes are not moved between the two process steps and are fixed on a cassette.
The basic design of the vacuum roller with one or more cutting units allows for various cutting strategies and thus optimal adaptation of the cutting process to the cutting position in space, the electrode contour, the electrode material and the laser parameters (scan feed, power, pulse duration, pulse repetition frequency, focus position).

Cutting strategies of preferred embodiments are:
Full cut: each cutting unit (one or more) separates the electrodes synchronously from the web. Variations are possible depending on the process speed and material.
   Option 1: the scanners operate time-synchronously, i.e. simultaneously
   Option 2: the scanners operate at the optimum angle of incidence, i.e. the cut is made quasi in the middle region of the working field. In doing so, the scanners can operate “in one another” also in cutting region of the working fields.

In a full cut:
Very high cycle times can be achieved because the cutting units only have to cover a minimal jump distance (distance from the end of the cut to the start of the cut) between the contour cut and the separation cut.
In addition, the synchronous full cut of each individual cutting unit, e.g. each individual laser, allows more time for the electrode to be cut out (increase of the part pitches). This means that the feed rate can be reduced while maintaining the same cut edge quality.
The jump distance/return can be adjusted depending on the web speed and the laser scan speed. The contours can be positioned on the cylindrical surface by moving them on the software side. In full cutting with focus on a simultaneous cut, a complete electrode sheet can be separated at a time t.
The limiting factor is always the effective laser track length in conjunction with the track speed and the scan field region (=cassette spacing on the vacuum roller).

Other embodiments can also provide for a series cut where one cutting unit only cuts a first part of the electrode contour and another cutting unit performs a separating cut while also severing portions that are produced when cutting the electrode contour. In the case of a separation cut in series, one of the lasers can be operated with different parameters than the other laser. The working field of the first scanner can be reduced to a minimal process area, thus also reducing the spot size and increasing the edge quality.

### BRIEF DESCRIPTION OF THE DRAWINGS

Embodiments of the invention are explained in more detail in the following with reference to the attached drawings in which:

FIG. 1 shows a partly perspective view and partly schematic block diagram of an embodiment of a cutting device designed to perform a cutting method for cutting electrode pieces;

FIG. 2 shows a plan view of a first embodiment of an electrode piece;

FIG. 3 shows a plan view of a second embodiment of an electrode piece;

FIG. 4 shows a plan view (in planar development) of a web-shaped electrode substrate when performing a first step of a preferred embodiment of the cutting method;

FIG. 5 shows a view as in FIG. 4 when performing a second step of the cutting process;

FIG. 6 shows a plan view (in plane development) of a web-shaped electrode substrate as an overview to explain the cutting method;

FIG. 7 shows a plan view (in plane development) of the web-shaped electrode substrate according to FIG. 6, with different cuts 1 to 4 of the cutting method of the preferred embodiment indicated;

FIG. 8 shows a plan view (in a plane development) of a part of the web-shaped electrode substrate of FIGS. 6 and 7 forming a later electrode piece, for explaining the cuts 1 and 2 of the cutting method of the second embodiment;

FIG. 9 shows a plan view as in FIG. 8, illustrating the execution of cut 3 of the cutting method of the second embodiment; and

FIG. 10 shows a plan view of an electrode web piece at which the contour of an arrester strip is already cut out after the first step of the cutting method of the first embodiment has been carried out, in this case in particular after cuts 1 to 3 have been made, wherein the execution of a separation cut according to the second step and in particular according to cut 4 of the cutting method is illustrated.

### DETAILED DESCRIPTION OF THE PREFERRED EMBODIMENTS

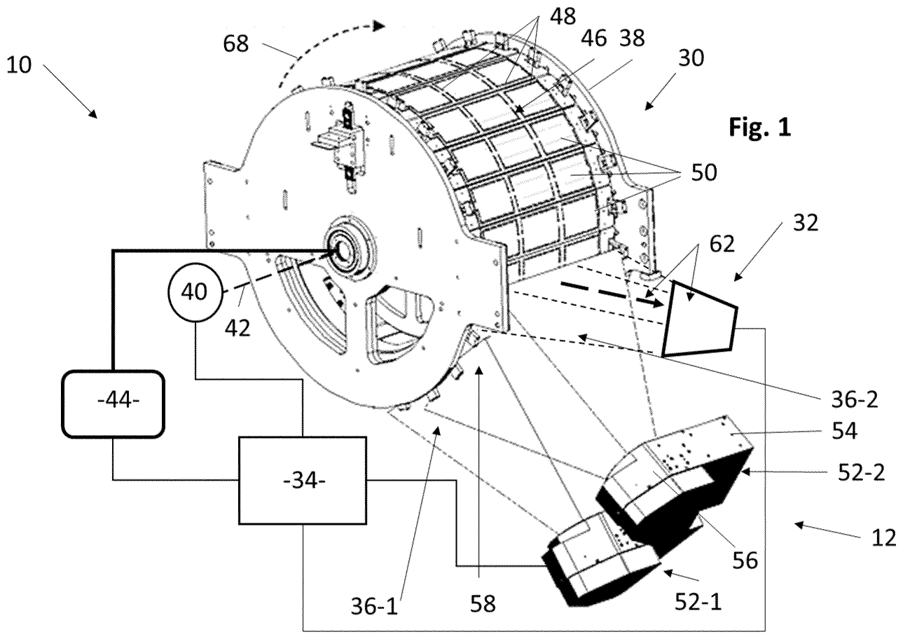

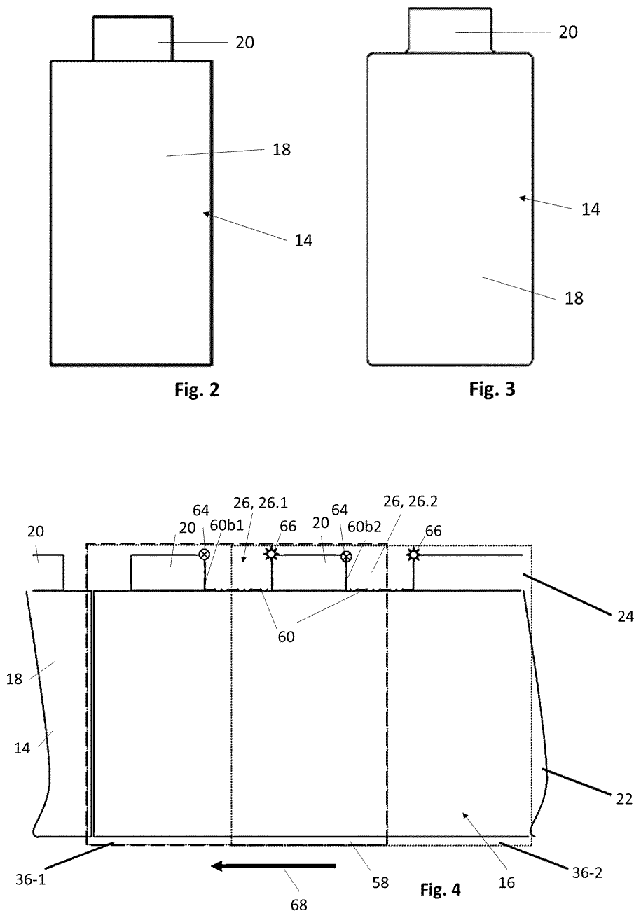

FIG. 1 shows a preferred embodiment of a cutting device 10 with cutting means 12 which is used in the large-scale production of batteries for electric vehicles to provide electrode pieces 14 to be stacked, as is known in principle from [1]. FIGS. 2 and 3 show preferred embodiments of electrode pieces 14 to be formed by cutting. FIGS. 4 to 10 show different steps of a preferred embodiment of a cutting method for forming such electrode pieces 14, preferably using the cutting device 10 of FIG. 1 (the cutting method can, however, be carried out with other cutting devices not shown in detail, e.g. with flat conveying).

The cutting method is to be carried out in the course of a series production of cell composites of batteries for the purpose of separating electrode pieces 14 from a web-shaped electrode substrate 16 using cutting means 12 in order to obtain electrode pieces 14 with a flat active material 18 and a lateral arrester tab 20. Preferred embodiments of the electrode pieces 14 are shown in FIGS. 2 and 3.

As shown in particular in FIGS. 4 to 10, the cutting method comprises the steps of:
a) providing the web-shaped electrode substrate 16, which has an active material region 22 preferably coated on one or two sides with active material 18 and a preferably uncoated arrester tab 20 on at least one side of the active material region 22, by conveying the web-shaped electrode substrate 16 to the cutting means 12;
b) cutting at least one arrester tab 20 free from the arrester strip 24, with an unneeded portion 26 of the arrester strip 24 being produced at least after the arrester tab 20 in the conveying direction (see in particular FIG. 4 and FIGS. 8 and 9),
c) singulating the electrode piece 14 provided with the arrester tab 20 which has been cut free by cutting through the electrode substrate 16 inclusive of the active material 18 and also through the portion 26 cut out in step b) (see in particular FIGS. 5, 6 and 10), and
d) removing the portion parts 28 (in particular those produced in step c) by cutting through the portion 26) from the cutting device 12.

The embodiment of the cutting device 10 shown in FIG. 1 is accordingly designed to cut out and cut off electrode pieces 14 from a web-shaped electrode substrate 16 in order to obtain electrode pieces 14, in particular as shown in FIGS. 2 and 3, having a flat active material 18 and a lateral arrester tab 20 for the series production of cell composites of batteries. In particular, the cutting device 10 is designed to carry out the aforementioned cutting method.

According to FIG. 1, the cutting device 10 comprises the cutting means 12, conveyor means 30, cut portion removal means 32 and a control system 34.

The conveyor 30 is designed to move the web-shaped electrode substrate 16 through a working region 36-1, 36-2 of the cutting means 12.

In the illustrated embodiment, the conveyor means 30 is designed as a vacuum roller 38 which is rotatable about an axis of rotation 42 by means of a rotary drive 40 and in which a vacuum can be generated by means of a suction device 44.

In the illustration of FIG. 1, the vacuum roller 38 is rotated in a clockwise direction; the direction of rotation here specifies a conveying direction 68 for conveying the electrode substrate 16 not shown in FIG. 1.

The circumferential surface 46 has a plurality of suction openings 48, so that the electrode substrate 16 and the cut-out electrode pieces 14 can be held on it by suction. A plurality of cassettes 50 are movably arranged on the circumferential surface 46, so that one cassette 50 is provided for each electrode piece 14. The suction openings 48 are provided on surface regions located further inwards of the cassettes 50 outside the cutting curves 60 still to be described.

The cassettes 50 are movable in a radial direction by means of a slotted guide (not shown) depending on the rotational position, in order to spatially separate the electrode pieces 14 cut by the cutting means 12 and to deliver them to a discharge point, in particular by blow-off or extraction. In particular, a vacuum roller 38 is used, as described and shown in more detail in literature [1]. As described and shown in [1], the web-shaped electrode substrate 16 is supplied to the vacuum roller 38 and moved by means of the vacuum roller 38 through the working region 36-1, 36-2 of the cutting means 12, so that the entire cutting process, as will be explained in more detail below, is carried out on the vacuum roller 38.

The transection (separation cut) is made in particular at the gap region between adjacent cassettes 50. At the lateral edge area of the circumferential surface 38, where the arrester strip 24 comes to rest and where the arrester tabs 20 are cut free, no suction openings 48 are provided in the illustrated design.

The cutting means 12 comprises at least one cutting unit 52-1, 52-2 which comprises cutting beam generating means 54 for generating a cutting beam and cutting beam deflection means 56. The control system 34 actuates the cutting unit 52-1, 52-2 to move the cutting beam along one or more predetermined cutting curves 60, 60b1, 60b2, 60c1, 60c2, 60.1, 60.2, 60.3, 60.4—examples of which are shown in FIGS. 4to 10—over the electrode substrate 16 moved by the conveyor means 30.

In the configurations shown, the cutting beam generating means 54 is formed by a laser. In some embodiments, the cutting beam deflection means 56 is formed by a scanner, in particular a 3D scanner with galvanometric axes.

In the illustrated example, the cutting means 12 has a first cutting unit 52-1 with a first working region 36-1 and a second cutting unit 52-2 with a second working region 36-2. The cutting unit 52-1, 52-2 is in each case formed by a laser system comprising a pulsed laser and a 3D scanner with galvanometric axes that can direct the cutting beam in each case to a point in the associated working region 36-1, 36-2.

The cutting units 52-1, 52-2 are arranged in the peripheral direction of the vacuum roller 38 and thus in the conveying direction 68 of the conveyor means 30 offset from one another, in particular arranged one behind the other, wherein the first and the second working regions 36-1, 36-2 can be arranged one after the other in the conveying direction 68 or offset from one another with an overlap region 58 as shown.

In the configurations shown, the first cutting unit 52-1 is arranged in front in the conveying direction 68 (at the bottom in FIG. 1), while the second cutting unit 52-2 is arranged to the back in the conveying direction 68 (FIG. 1 above). The definitions of “first” and “second” are arbitrary. In this case, the “first cutting unit 52-1” is the one that cuts further ahead in the conveying direction 68, but in practice the electrode substrate 16 first passes through the working region 36-2 of the second cutting unit 52-2 and then through the working region 36-1 of the first cutting unit 52-1.

The cut portion removal means 32 is designed to completely remove the portions 26, in particular by removing the smaller portion parts 28. Removal takes place at the location and time the portion parts 28 are cut off, preferably by extraction or blow-off. In preferred embodiments, the cut portion removal means 32 has a suction device 62 which extracts particles produced during cutting from the working region 36-1, 36-2 and from the vacuum roller 38. Preferably, the suction device 62 operates permanently. Before a cutting process is started, the control system 34 queries the operation state of the suction device 62 and only carries out a cutting process when the suction device 62 is operating.

The control system 34 is further designed to move the cutting units 52-1, 52-2 through the cutting curves 60, 60b1, 60b2, 60c1, 60c2, 60.1, 60.2, 60.3, 60.4, as will be explained in more detail below with reference to FIGS. 4 to 10.

The cutting curves 60, 60b1, 60b2, 60c1, 60c2, 60.1, 60.2, 60.3, 60.4 are laser tracks along which the respective laser beam is guided for cutting. The cutting curves 60, 60b1, 60b2, 60c1, 60c2, 60.1, 60.2, 60.3, 60.4 are automatically calculated by the control system 34 depending on the conveying speed-here the rotational speed of the vacuum roller 38—in order to carry out the cutting process during each conveying operation. Furthermore, the cutting beam, in this case the laser beam, is activated or faded in at the beam entry points, indicated by the circle with cross (beginning of the respective cutting curve 60, 60b1, 60b2, 60c1, 60c2, 60.1, 60.2, 60.3, 60.4), and deactivated or faded out at the beam exit points 66, indicated by the star symbol in the FIGS. 4 to 10 (end of the respective cutting curve 60, 60b1, 60b2, 60c1, 60c2, 60.1, 60.2, 60.3, 60.4), by the control system 34.

As already explained, the laser system is composed of at least one laser beam source and at least one optical deflection unit. After the singulation process on the vacuum roller 38, a deflection of the laser beam in space (including height adjustment of the working plane) is provided. In preferred embodiments, a 3D scanner with galvanometric axes is used for this purpose.

In preferred embodiments, pulsed or continuous fiber lasers are used as the beam source.

The cutting curve 60, 60b1, 60b2, 60c1, 60c2, 60.1, 60.2, 60.3, 60.4 or the cutting curve for producing the individual electrodes 14 is created by synchronizing the rotational movement of the vacuum roller 38 and the cutting movement in the working region 36-1, 36-2 of the deflection unit of the cutting beam deflection means 56.

Since the cutting speed can vary, e.g. due to specific workpiece properties (format size, coating thickness, coating material, etc.), various cutting strategies have been developed to keep the cycle time. The system design with two (or more) cutting units 52-1, 52-2 allows for different cutting strategies, which also bring different advantages.

In addition, the cuts can also be made over several passes, depending on the material.

FIGS. 2 and 3 show an overview of possible electrode shapes. FIG. 2 shows an electrode piece 14 with a sharp-edged contour, while FIG. 3 shows an electrode piece 14 with a rounded contour.

FIGS. 4 to 10 show examples of cutting curves 60, 60b1, 60b2, 60c1, 60c2, 60.1, 60.2, 60.3, 60.4 for cutting strategies for synchronous singulation steps.

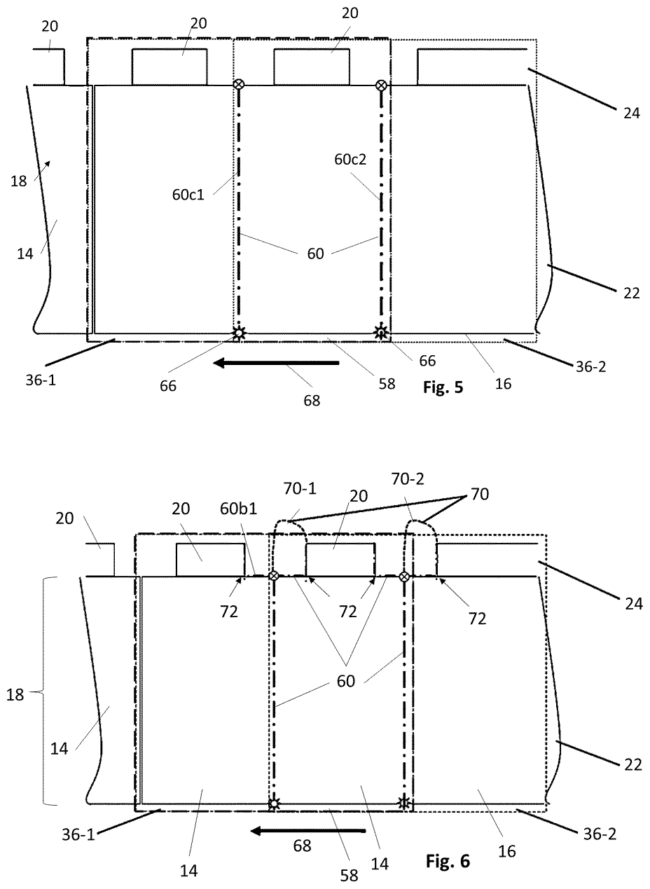

In FIG. 4, a free cut 60b1, 60b2 of the arrester tab 20 by the first cutting unit 52-1 and the second cutting unit 52-2 is shown schematically in overview. The arrow 68 indicates the material flow or, in other words, the conveying direction of the conveyor means 30. FIG. 5 schematically shows an overview of the respective separation cut 60c1, 60c2 through the first cutting unit 52-1 and the second cutting unit 52-2 (the precise progression of the separation cut 60c1, 60c2 is shown in FIG. 10). FIG. 6 schematically shows the cutting strategy resulting from the sequence of FIGS. 4 and 5 with the jump 70 and the jump distance 70-1, 70-2 of the first and second cutting unit 52-1, 52-2.

Accordingly, in the illustrated embodiment of the cutting method in step b), the first cutting unit 52-1 cuts out a first portion 26-1 before of the arrester tab 20 in the conveying direction 68 and, synchronously or at least overlapping in time, a second portion 26-2 located behind that arrester tab 20 in the conveying direction 68 is cut out by means of the second cutting unit 52-2. Then, in step c), a front transection—in this case the separation cut 60c1—in the conveying direction 68 is made by means of the first cutting unit 52-1, and a rear transection—in this case the separation cut 60c2—in the conveying direction 68 is made synchronously or with a time overlap by means of the second cutting unit 52-2.

In this cutting strategy, both cutting units 52-1, 52-2 or the scanner operate synchronously. In the first cutting phase, the arrester—arrester tab 20—is cut out. Thereafter the scanner separates the electrode.

One advantage of this cutting process is that—as shown in FIG. 10—the portion 26 from the arrester strip 24, after it has been separated from the web in the first singulation cut, is separated into two portion parts 28 by the directly following transversal cut at the level of the gap between adjacent cassettes 50. Dividing the arrester portions 26 (halving the weight to be extracted) reduces the risk of the portion 26 not being completely removed from the process zone. This minimizes the risk of the portion 26 influencing the laser beam, which could thus interfere with the subsequent cut. Since the portions 26 are extracted during the process, the portion 26 can thus be halved again and the risk of negative influences in the overall process can be significantly reduced.

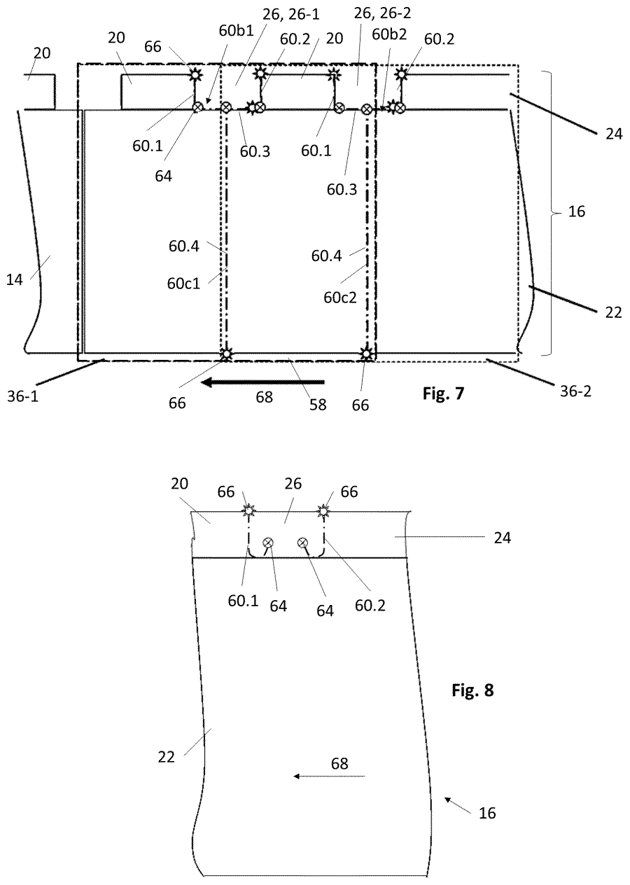

FIG. 7 shows a 3-part cut of the respective free cut 60b1, 60b2 and the separation cut 60c1, 60c2 to be performed as the fourth cut. Each overall cutting curve 60 of the respective cutting unit 52-1, 52-2 includes the individual cutting curves 60.1, 60.2, 60.3 and 60.4.

FIG. 8 shows the partial cuts 60.1 and 60.2 to cut the edges free in the direction transverse to the conveying direction 68. The cutting beam (e.g. laser) enters at the corner or radius transition from the active material region to the arrester region and then runs upwards and out of the arrester strip 24. Thus, in these first cuts 60.1, 60.2, the two legs of the arrester shown vertically in FIG. 8 are cut. In the illustrated embodiment of the partial cuts 60.1, 60.2, the cutting beam enters in each case at a beam entry point 66 in the interior of a region of the arrester strip 24, which region later forms the portion 26 to be discarded. Thus, any possible impairment of the material at the entry of the beam is negligible, since this region of the material is discarded as the portion 26 anyway. From the beam entry point 66, the cutting beam is then guided to the corner region 72 between the active material 18 and the edge of the arrester tab 20 that is to be cut free, where—depending on the contour of the electrode 14—a rounding can be created. Then the cutting beam is guided from the corner region 72 through the arrester strip 24 outwards to cut the edge free and is then switched off.

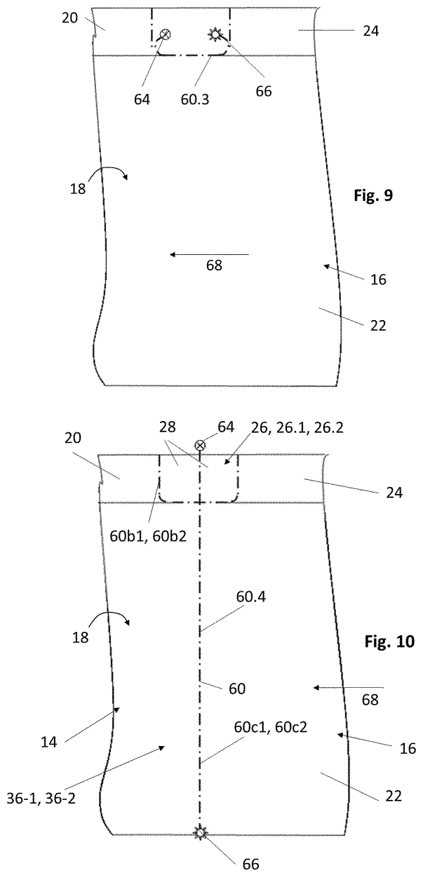

In the partial cut 60.3 shown in FIG. 9 of the free cut 60b1, 60b2, the portion 26 is cut along the boundary of the active material 18 extending in the conveying direction 68. Here, too, the cutting beam enters in the interior of the later portion 26, is then guided to the corner region 72 and then along the boundary. The cutting beam is then directed into the interior of the portion 26 again and then switched off or faded out.

The laser enters again in the corner or radius transition, but now from the opposite direction. Then the cut is made parallel to the coating edge, in turn ending in the corner area.

Thus, the portion 26 between two arrester tabs 20 is completely cut out.

FIG. 10 shows the subsequent partial cut 60.4 for performing the separation cut 60c1 or 60c2 in greater detail. The cutting beam is guided here from outside the electrode substrate 16 first through portion 26 of the arrester strip 24 and then through the active material region 22, in order to separate the electrode piece 14 at the front in the conveying direction from the remaining electrode substrate 16, essentially transversely to the conveying direction.

In the process, the laser separates the electrodes in a transverse cut, entering above the cut-out region—portion 26—and thus additionally halving it.

Thus, according to FIGS. 7 and 8, step b) of performing free cutting 60b1, 60b2 of the arrester tab 20 is preferably carried out with the steps:
b1) directing the at least one cutting beam along a front cutting curve 60.1 which extends from a beam entry point 66 in the interior of the region of the arrester strip 24 forming the later unneeded portion 26 of the arrester strip 24 to a front corner region 72 between an arrester tab 20 at the front in the conveying direction and the active material 18 of the electrode piece 14 and then extends outwards from the front corner region 72 in a direction transverse to the conveying direction 68, in order to separate the front arrester tab 20 from the remaining unneeded portion 26 of the arrester strip 24;
b2) directing the at least one cutting beam along a rear cutting curve 60.2 which extends from a beam entry point 66 in the interior of the region of the arrester strip 24 forming the later unneeded portion 26 of the arrester strip 24 to a rear corner region 72 between an arrester tab 20 which is at the rear with respect to the conveying direction 68 and the active material 18 of the electrode piece and then extends outwards from the rear corner region 72 in a direction transverse to the conveying direction 68, in order to separate the rear arrester tab 20 from the remaining unneeded portion 26 of the arrester strip 24;
b3) directing the cutting beam along a middle cutting curve 60.3 which extends from the interior of the portion 26 to a corner region 72 between a first arrester tab 20 and the active material 18 of the electrode piece 14, then in a direction parallel to the conveying direction 68 (e.g. in FIG. 9 the cut 60.3 is made against the conveying direction 68) to create an end edge of the active material 18 of the electrode piece 14 between the first arrester tab 20 and a second arrester tab 20 adjacent to the first, and from the corner region 72 between the second arrester tab 20 and the active material 18 into the interior of the portion 26 and ends there.

According to FIG. 10, step c) of the cutting process-separation cut 60c1, 60c2—of the electrode piece 14 is preferably carried out with step:
c1) directing the at least one cutting beam along a singulation cutting curve 60.4, which extends from outside the arrester strip 24 through portion 26 across the electrode substrate 16 for singulation the electrode piece 14.

The control system 34 of the cutting device 10 is designed to automatically control the cutting device 10 to carry out the cutting method described above. The control system 34 is in particular designed as an electronic control system, in particular as a computer unit or computer with a corresponding computer program that contains the corresponding instructions.

The cutting method is carried out in particular as a sub-process in the large-scale production of high-voltage batteries for electric vehicles. The cutting device 10 preferably forms part of a corresponding manufacturing plant. For further details, reference is made to literature [1].

In order to improve the separation of electrode pieces for the large-scale production of battery cells for electric vehicles or the like, a cutting method and a cutting device (10) have been described in which during conveying of an electrode substrate (16) through cutting means (12) at least one arrester tab (20) is cut free from an arrester strip of an electrode substrate (16), a portion (26) of unneeded material being produced in the arrester strip (24) after of the arrester tab (20) when viewed in a conveying direction (68), and then the electrode pieces (14) provided with the arrester tab (20) which has been cut free are singulated by cutting through the electrode substrate (16) inclusive of the active material (18) and also the portion (26) cut out in step b). The portion (26) is thus reduced in size and can be removed more reliably from the cutting device (12).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 cutting device
12 cutting means
14 electrode piece
16 web-shaped electrode substrate
18 active material
20 arrester tab
22 active material region
24 arrester strip
26 portion
26-1 first portion
26-2 second portion
28 portion part
30 conveyor means
32 cut portion removal means
34 control system
36-1 first working region
36-2 second working region
38 vacuum roller
40 rotary drive
42 rotary axis
44 suction means
46 peripheral surface
48 suction opening
50 cassettes
52-1 first cutting unit
52-2 second cutting unit
54 cutting beam generating means
56 cutting beam deflection means
58 overlap region
60 cutting curve
60b1 cutting curve for free cut by first cutting unit
60b2 cutting curve for free cut by second cutting unit
60c1 cutting curve for separation cut by first cutting unit
60c2 cutting curve for separation cut by second cutting unit
60.1 cutting curve first partial cut (front cutting curve)
60.2 cutting curve second partial cut (rear cutting curve)
60.3 cutting curve third partial cut (middle cutting curve)
60.4c cutting curve fourth partial cut (separation cut for transection, transverse cut)
62 extraction
64 beam entry point
66 beam exit point
68 conveying direction (material flow)
70 jump
70-1 jump distance of first cutting unit
70-2 jump distance of second cutting unit
72 corner region

1-13. (canceled)

14. A method for cutting during a series production of cell composites of batteries for singulation electrode pieces from an electrode substrate using cutting means, so as to obtain electrode pieces with a flat active material and a lateral arrester tab, the method comprising:
a) providing an electrode substrate having an active material region and an arrester strip on at least one side of the active material region by conveying the electrode substrate to a cutting means;
b) cutting at least one arrester tab free from the arrester strip, a portion of unneeded material of the arrester strip being produced before, or after, or both the at least one arrester tab in a conveying direction;
c) singulating an electrode piece provided with the arrester tab cut free by cutting through the electrode substrate including the active material and the portion of unneeded material cut out in step b), and
d) removing the portion of unneeded material from the cutting means.

15. The method according to claim 14, wherein step a) comprises at least the step of:
a1) conveying the electrode substrate through two successive, or overlapping, or both working regions of a first cutting unit and a second cutting unit of the cutting means; and,
wherein a first portion of unneeded material located before the at least one arrester tab in the conveying direction is cut out by with the first cutting unit and, simultaneously, synchronously or with a time overlap, a second portion of unneeded material located behind that arrester tab in the conveying direction is cut out with the second cutting unit, or
wherein in step c) a front transection, viewed in the conveying direction, is made with the first cutting unit and, simultaneously, synchronously or at least with a time overlap, a rear transection, viewed in the conveying direction, is made with the second cutting unit, or
both.

16. The method according to claim 14, further comprising:
generating at least one cutting beam, and
directing the at least one cutting beam along cutting curves in order to carry out steps b) and c).

17. The method according to claim 16, wherein step b) comprises at least one or more of the steps:
b1) directing the at least one cutting beam along a front cutting curve which extends from a beam entry point in an interior of a region of the arrester strip forming the portion of unneeded material to a front corner region between an arrester tab which is at the front with respect to the conveying direction and the active material of the electrode piece and then extends outwards from the front corner region in a direction transverse to the conveying direction, in order to separate the front arrester tab from the portion of unneeded material of the arrester strip;
b2) directing the at least one cutting beam along a rear cutting curve which extends from a beam entry point in an interior of a region of the arrester strip forming the portion of unneeded material to a rear corner region between an arrester tab which is at the rear with respect to the conveying direction and the active material of the electrode piece and then extends outwards from the rear corner region in a direction transverse to the conveying direction to separate the rear arrester tab from the portion of unneeded material of the arrester strip;
b3) directing the cutting beam along a middle cutting curve which extends from an interior of the portion of unneeded material to a corner region between a first arrester tab and the active material of the electrode piece, then extends in or against the conveying direction to create an end edge of the active material of the electrode piece between the first arrester tab and a second arrester tab adjacent to the first, and extends from the corner region between the second arrester tab and the active material into the interior of the portion of unneeded material and ends there.

18. The method according to claim 16, wherein step c) comprises:
c1) directing the at least one cutting beam along a singulation cutting curve which extends from outside the arrester strip through the portion of unneeded material transversely through the electrode substrate for singulating the electrode piece.

19. The method according to claim 17, wherein step c) comprises:
c1) directing the at least one cutting beam along a singulation cutting curve which extends from outside the arrester strip through the portion of unneeded material transversely through the electrode substrate for singulating the electrode piece; and,
wherein
the cutting beam successively traverses cutting curves, or
the middle cutting curve is traversed after the front and the rear cutting curves, or
the steps are carried out in the order of b1), b2), b3) and c1), or
any combination thereof.

20. The method according to claim 14, wherein step d) comprises:
blowing off, extracting, or both the portion of unneeded material

21. A device for cutting out and cutting off electrode pieces from an electrode substrate in order to obtain electrode pieces with flat active material and a lateral arrester tab for a series production of cell composites of batteries, the cutting device comprising:
cutting means,
conveyor means for conveying an electrode substrate having an active material region and an arrester strip on at least one side of the active material region through a working region of the cutting means,
cut portion removal means for removing unneeded portions produced during cutting,
and a control system configured to cause the cutting means to:
cut at least one arrester tab free from the arrester strip, wherein after the at least one arrester tab in the conveying direction a portion of unneeded material of the arrester strip is produced, and
carry out a cut both through the electrode piece provided with the arrester tab that has been cut free and also through the portion of unneeded material cut out in order to singulate the electrode piece and to divide the portion of unneeded material into a plurality of portion parts in order to remove these by the cut portion removal means.

22. The device according to claim 21, further comprising:
at least one cutting unit comprises cutting beam generating means for generating a cutting beam, and cutting beam deflection means,
wherein the control system is configured to cause the cutting unit to move the cutting beam along one or more predetermined cutting curves over the electrode substrate conveyed by the conveyor means.

23. The device according to claim 21, wherein the cutting means has a first cutting unit with a first working region and a second cutting unit with a second working region which are arranged one behind the other, or overlapping, or both in the conveying direction of the conveyor means,
and wherein the control system is configured to cause the cutting means:
to cut out, with the first cutting unit, a first portion of unneeded material before the arrester tab in the conveying direction and, simultaneously, synchronously or with a time overlap, to cut out, with the second cutting unit, a second portion of unneeded material after that arrester tab in the conveying direction, or
to carry out a front transection, viewed in the conveying direction, with the first cutting unit and, simultaneously, synchronously, or at least with an overlap in time, to carry out a rear transection, viewed in the conveying direction, with the second cutting unit.

24. The device according to claim 22, wherein the control system is configured to cause the cutting beam deflection means
b1) to traverse, with the cutting beam, a front cutting curve that extends from a beam entry point in an interior of a region of the arrester strip which forms the portion of unneeded material to a front corner region between an arrester tab which is at the front with respect to the conveying direction and the active material of the electrode piece and then extends outwards from the front corner region in a direction transverse to the conveying direction, in order to separate the front arrester tab from the portion of unneeded material of the arrester strip; or
b2) to traverse, with the cutting beam, a rear cutting curve that extends from a beam entry point in an interior of an region of the arrester strip forming the portion of unneeded material to a rear corner region between a rear arrester tab and the active material of the electrode piece and then extends outwards from the rear corner region in a direction transverse to the portion of unneeded material of the arrester strip; or
b3) to traverse, with the cutting beam, a middle cutting curve that extends from an interior of the portion of unneeded material to a corner region between a first arrester tab and the active material of the electrode piece, then in or against the conveying direction to create an end edge of the active material of the electrode piece between the first arrester tab and a second arrester tab adjacent to the first arrester tab, and from the corner region between the second arrester tab and the active material into the interior of the portion of unneeded material and ends there.

25. The device according to claim 22, wherein the control system is configured to cause the cutting beam deflection means to
c1) traverse, with the cutting beam, a singulation cutting curve that extends from outside the arrester strip through the portion of unneeded material transversely through the electrode substrate for singulating the electrode piece.

26. A non-transitory computer readable media storing a computer program comprising instructions that cause a cutting device to carry out the cutting method according to claim 14.
